(19) United States
(12) Patent Application Publication
(10) Pub. No.: US 2003/0195818 A1
(43) Pub. Date: Oct. 16, 2003

(54) Portable sales assistant terminal system

(76) Inventors: Patrick Howell, Spring Valley, CA (US); John Kaczmarowski, Du cote droit de la cour (FR); Virginia Keating, Encinitas, CA (US); Larry Mittag, Ramona, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/123,931

(22) Filed: Apr. 16, 2002

(51) Int. Cl. G06F 17/60

(52) U.S. Cl. 705/26

(57) ABSTRACT

In summary, the present invention relates to a portable shopping system including a plurality of portable terminals. Each portable terminal incorporates a scanning unit for acquiring product identification information associated with selected products. The system further includes a wireless communication network for communicating the acquired product identification information provided by the plurality of portable terminals to a central host facility. Included within the central host facility is an access point disposed to receive the product identification information from the wireless communication network and a central database including a plurality of personal shopping files respectively associated with the plurality of portable terminals. The central host facility also includes a central controller operative to update ones of the personal shopping files upon receipt of portions of the product identification information provided by associated ones of the portable terminals. The system may also include at least one self-checkout unit in communication with the central host facility for processing a self-checkout transactions involving items selected using the plurality of portable terminals. The self-checkout transactions each generally involve downloading of a list of items from a personal shopping file in response to presentment of an associated one of the portable terminals at the self-checkout unit.

### FIELD OF THE INVENTION

This invention relates generally to a system and method for ordering, supplying and obtaining information relating to selected goods and services using a portable sales assistant terminal.

### BACKGROUND OF THE INVENTION

Consumers often desire to obtain information about products and services that are being offered for sale. Such information may relate to price, product size, instructions for use, product applications, warranty, warnings, rating by independent testing organizations, product demonstrations or samples, service information, and background, biographical or historical information about the creator, service provider, manufacturer, or seller.

It is common practice to attach certain of such desired information to the relevant product or to supply it as part of the service. However, consumers may still have an unfilled need for accurate, up to date, relevant, and appropriate information for a variety of reasons. For example, space may be limited on the product package or display. In addition, the information may be change rapidly, and obsolete information may be useless or misleading. On the other hand, there may even be too much information, and consumers may require assistance in sorting through it to find the information that is most relevant to their needs. For example, although there is an enormous amount of information available on the Internet, it is often difficult for consumers to locate and even more difficult for consumers to relate the information to the precise product of interest.

Retailers, distributors, packagers, and service providers may be aware of these needs of consumers for information about products and services, and may wish to provide such information to consumers in order to increase sales and profits. Knowing which consumers show an interest in or purchase various products may help marketing resources be allocated most effectively. Also, obtaining information about which consumers choose not buy a product or service after considering a purchase may be even more important than obtaining information about those consumers who do choose to buy a particular product or service. In addition, different customers may need or desire different types of information. In order for a product or service provider to provide relevant information to the consumer, it is necessary to first obtain information from the consumer about the consumer's needs.

Various mechanisms have been proposed for enhancing the delivery of information about certain products and services indicated by consumers to be of interest based upon indications of consumer preference. For example, in certain systems machine readable coded labels are placed upon products and used to encode one or more remote file locations, such as uniform resource locators (“URLs”), used to reference sites on the world wide web (“WWW”). These labels are scanned by a hand-held terminal issued to a consumer, thereby enabling the retrieval of data files including items such as prices, promotions, marketing and general interest data from various local and remote addresses available over a wireless communication network. These URLs can be presented on the terminal display in the form of a hyperlink which submits a data retrieval request to a remote address upon selection. Although such systems enable more targeted distribution of marketing and other product-related information, such distribution is typically based only upon the identity of the product scanned by the hand-held terminal. That is, such systems are limited to obtaining information pertinent to the scanned product, and are not generally designed to provide such information based at least in part upon other indicia of consumer preference (e.g., prior purchasing or browsing history).

In addition to facilitating the targeted provision of product-related information, such hand-held terminals have also been utilized in other “portable” shopping systems. For example, in one such system an authorized customer is issued a terminal having an integrated bar code scanner to record merchandise purchases. After items are scanned with the bar code scanner, the terminal maintains a record of merchandise selected for purchase by the customer within an internal memory. Prior to exiting the store, the information stored in the memory of the scanner is down loaded through a communication port attached to a terminal dispenser, and a printed ticket of the customer's purchases is printed on a printer. The customer then proceeds to a check out register where the customer tenders payment for the purchased merchandise.

In another proposed portable shopping system, a consumer is provided with a hand-held bar code reader and can scan various items at home. The user can order from home over a modem, or can dock the bar code reader in a kiosk at a store, and can then receive a printed shopping list with directions. Yet further, a list of items can be transmitted from the store kiosk to a warehouse for remote picking.

Consistent with the above, commercially available prior art self-checkout systems have generally employed relatively simple portable computing technologies disposed to provide limited pricing and product itemization information. Moreover, lists of products selected for purchase and other product-related information is often stored within the portable units utilized within such systems, which tends to increase the processing and memory requirements of such units. In addition, although the pervasiveness of networked computing and the Internet has facilitated access to product-related information, it has not yet fundamentally changed the manner in which consumers select, purchase and receive most goods and other items.

Accordingly, there currently exists a need for a system for enabling more sophisticated and focused delivery of product-related information and for streamlining product ordering and fulfillment.

### SUMMARY OF THE INVENTION

In summary, the present invention relates to a portable shopping system including a plurality of portable terminals. Each portable terminal incorporates a scanning unit for acquiring product identification information associated with selected products. The system further includes a wireless communication network for communicating the acquired product identification information provided by the plurality of portable terminals to a central host facility. Included within the central host facility is an access point disposed to receive the product identification information from the wireless communication network and a central database including a plurality of personal shopping files respectively associated with the plurality of portable terminals. The central host facility also includes a central controller operative to update ones of the personal shopping files upon receipt of portions of the product identification information provided by associated ones of the portable terminals.

In another aspect, the present invention relates to a portable sales assistant terminal including a processor, a memory coupled to the processor, and a scanning unit. The memory preferably stores persistent browser state information externally associated with the shopping terminal. During operation of the portable sales assistant terminal, the scanning unit scans products of interest and provides associated product identification information to the processor. A wireless transceiver circuit coupled to the processor operates to (i) transmit the product identification information via a wireless communication channel, and (ii) receive corresponding product information. The portable sales assistant terminal further includes a display/user input device for displaying the product information through a browser executed by the processor.

In yet another aspect, the present invention comprises a system for self-checkout by a customer. The system includes a central host facility incorporating a central database in which is maintained a personal shopping file associated with the customer. A portable terminal having a scanning unit is provided for acquiring product identification information from items selected by the customer. A wireless communication network operates to enable communication between the central host facility and the portable terminal. To this end, the portable unit transmits the acquired product identification information to the central host facility via the wireless communication network. In response, a list of the items is stored within the personal shopping file in response to receipt at the central host facility of the product identification information. The system includes at least one self-checkout unit in communication with the central host facility for processing a self-checkout transaction involving the items selected by the customer. The self-checkout transaction includes downloading the list of items from the customer's personal shopping file in response to presentment of the portable terminal at said self-checkout unit.

The present invention also relates to a method for providing product marketing information to at least one customer by way of a portable terminal operative in a self-checkout system, the portable terminal having an integrated scanning unit. The method contemplates storing a customer data file associated with the customer at a central host facility, the customer data file being identified by a customer identification number and including customer preference information created on the basis of shopping activity of the customer during one or more prior shopping sessions. During a current shopping session, a customer identification number is entered into the portable terminal and is transmitted to the central host facility via a wireless communication network. The integrated scanning unit is utilized to acquire product identification information associated with a product, and the acquired identification information is transmitted to the central host facility. In response, the central host facility then transmits product marketing information to the portable terminal via the wireless communication network. The product market information may be selected based upon the customer data file and the product identification information.

### BRIEF DESCRIPTION OF THE DRAWINGS

For a better understanding of the nature of the features of the invention, reference should be made to the following detailed description taken in conjunction with the accompanying drawings, in which:

FIGS. 1A and 1B provide similar illustrative overviews of a portable sales assistant terminal system of the present invention.

FIG. 2 illustratively represents a digital sales assistant (“DSA”) disposed to be used within the system of the present invention.

FIG. 3 provides a block diagrammatic representation of an exemplary internal architecture of a DSA in accordance with the present invention.

FIG. 4 is a block diagram of a central host facility configured within a retail establishment in accordance with the present invention.

FIG. 5A illustratively represents an exemplary data structure corresponding to a product database disposed within the central host facility of FIG. 4.

FIG. 5A illustratively represents an exemplary data structure corresponding to a customer database disposed within the central host facility of FIG. 4.

FIG. 6 provides a block diagram of an exemplary self-checkout station including a self-checkout terminal and an attached scanning unit.

FIG. 7 is a flowchart providing a general overview of exemplary operation of the portable terminal system.

FIG. 8 is a flowchart providing a more detailed representation of an exemplary self-checkout process occurring at a self-checkout station.

FIG. 9 is a flowchart providing a more detailed representation of one manner in which the system of the present invention may provide relevant product information to customers within a retail establishment.

FIG. 10 is a flowchart depicting the processing associated with the dedicated keys of the DSA.

FIG. 11 provides a block diagrammatic representation of a corporate data center configured in accordance with the present invention.

### DETAILED DESCRIPTION OF THE INVENTION

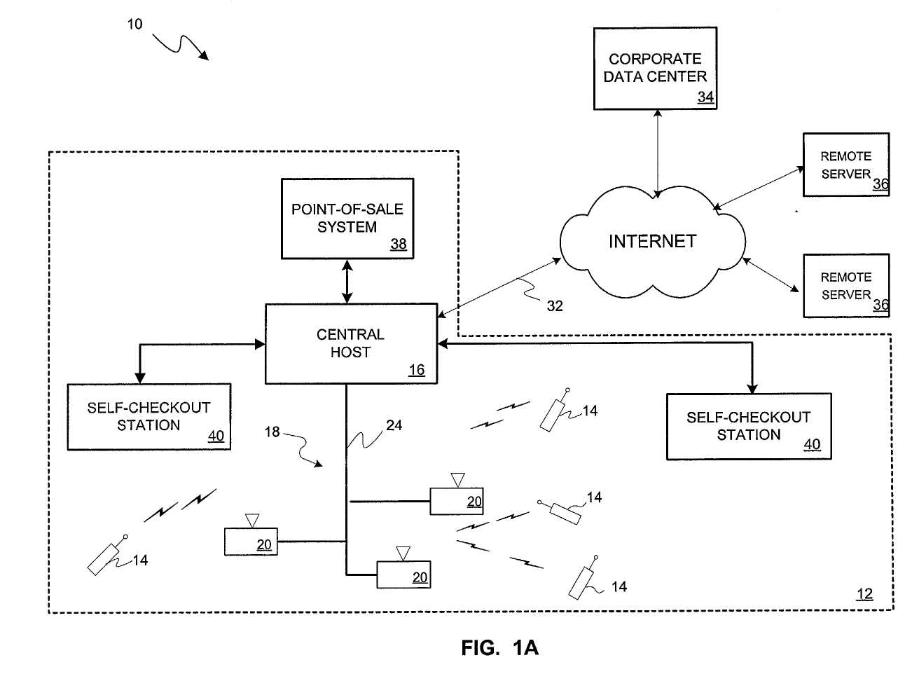

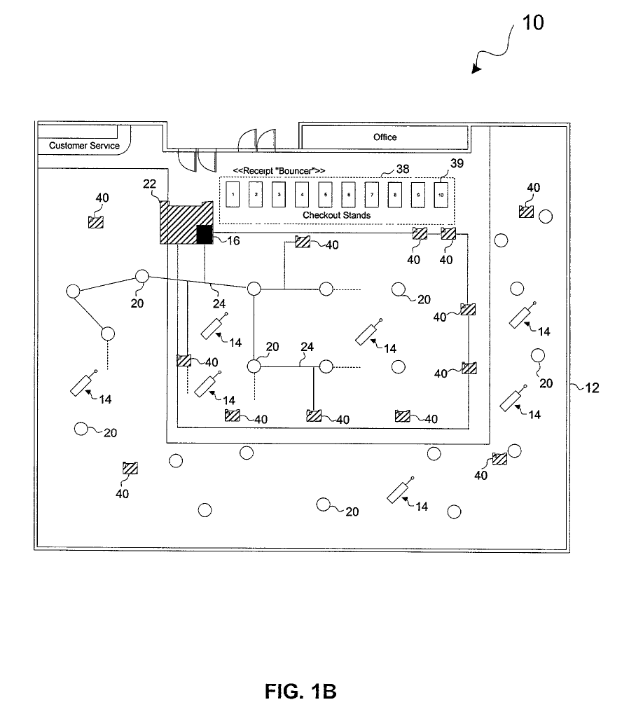

FIGS. 1A and 1B provide illustrative overviews of a portable sales assistant terminal system 10 of the present invention. In a particular embodiment, the system 10 is deployed throughout a plurality of retail establishments (e.g., individual stores of a retail chain), one of which is represented in FIGS. 1A and 1B by reference numeral 12. Within retail establishment 12, a plurality of portable digital sales assistant terminals (“DSAs”) 14 are communicatively linked to a central host facility 16 by a wireless communication network 18. As shown, the wireless communication network 18 includes a plurality of access points 20 linked by a local area network (“LAN”) 24 (e.g., an Ethernet LAN). For purposes of clarity, only a portion of LAN 24 is depicted in FIG. 1. A transceiver within each DSA 14 communicates with a similar transceiver in one of the plurality of access points 20 distributed throughout the retail establishment 12. As shown, each access point 20 interfaces with the central host facility 16 via the LAN 24. The central host facility 16 also interfaces with a point-of-sale (“POS”) system 38 of the retail establishment, and with a plurality of self-checkout stations 40 via LAN 24.

As shown in FIG. 1A, the central host facility 16 is connected to the Internet and a corporate data center 34 through one or more high speed communication links 32 such as, for example, commercially available digital subscriber line (“DSL”) or high speed T1, T2 or T3 type telephone connections. Through these connections the central host facility 16 communicates with the CDC 34, and may also communicate with other external remote servers 36 via links 32 using standard TCP/IP and other standardized communication protocols. As is discussed below, the CDC 34 stores sales and marketing content distributed to one or more retail centers such as the retail establishment 12. The CDC 34 may also host various corporate legacy systems and databases, and comparative product information.

As is discussed below, customers entering the retail establishment 12 have the option of being issued a DSA 14. Each DSA 14 contains a scanning unit 30 (i.e., a “scanner”) that is capable of scanning information encoded upon items available for purchase with in the retail establishment. Upon identifying an item of potential interest, the customer may use the DSA 14 to scan a machine code label or the like affixed to the item of interest and transmit the scanned product information to central host facility 16 via an access point 20 of LAN 24. In response, host facility 16 provides information pertaining to the identified product and may also furnish information relating to similar or superior products in order to enhance “up-sell” and “cross-sell” opportunities. If a customer desires to purchase an item, the item may be similarly scanned and the corresponding product identification information provided to central host facility 16 in order to update the contents of a virtual shopping cart for the customer maintained therein. Upon finishing shopping within the retail establishment 12, the customer proceeds to one of a number of self-checkout stations 40 distributed throughout the retail establishment 12 to checkout and otherwise render payment for the items the customer has previously selected for purchase. As part of this self-checkout process, a self-checkout station 40 accepts identification information from the customer's DSA 14 and uses this information to recall the contents of the customer's virtual shopping cart maintained by the central host facility 16.

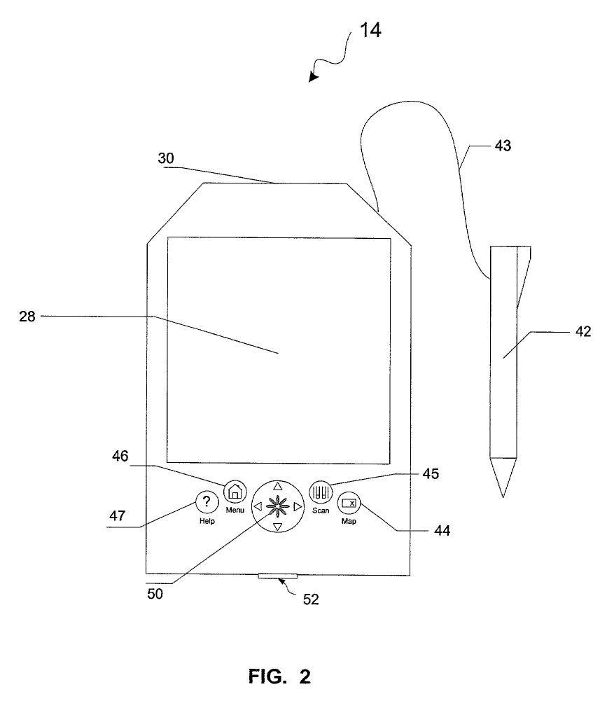

FIG. 2 illustratively represents a DSA 14 disposed to be used within the system 10 of the present invention. As shown, the DSA 14 includes the interactive touch display screen 28, which is typically a conventional video display having a touch sensitive surface. The touch display screen 28 is designed to serve as both a video display and as a user input interface. A stylus 42 attached by a retractable cord 43 will also typically be provided for use in entering information into, and selecting among options presented by, the interactive touch display screen 28.

In operation, the DSA 14 generally operates as a TCP/IP web browser which issues product selection and information requests to central host facility 16. After receiving product-related data in response to such information requests as described above, the DSA displays hyper-text mark-up language (“HTML”) web pages to the requesting customer via an interactive touch display screen 28. The DSA 14 may generate such requests based upon at least one of: (a) encoded product identification information read by a scanning unit 30 from labels disposed upon articles disposed within the retail establishment 12, and (b) data input manually via interactive touch display screen 28. Although the scanning unit 30 preferably comprises a bar code laser scanner integrated with the DSA 14, it will be understood by those skilled in the art that the scanning unit can be a radio frequency identification tag reader, a CCD bar code reader or any other type of scanning unit which can decode encoded indicia on an article.

The DSA 14 will also preferably be configured to include a number of special purpose keys 44, 45, 46 and 47 for directly activating various functions. For example, the DSA 14 includes a “Map” key 44 which, upon being selected, results in the touch display screen 28 presenting a map of the particular retail establishment in which the system 10 is disposed. As is discussed further below, a “Scan” key 45 is selected to initiate the scanning by the scanning unit 30 of encoded product identification labels affixed to products of interest. Selection of a “Menu” key 46 causes the display screen 28 to present a “main menu” page comprised of various menu options. Finally, a “Help” key 47 may be chosen when it desired to view a list of available help topics via display screen 20.

Referring again to FIG. 2, the DSA 14 is also typically equipped with a speaker 50 used to project information transmitted by the central host facility 16 in an audio format. For example, the speaker 50 could be used to convey information relating to store hours, sales, or general product information. An earpiece (not shown) could be offered as an option to hearing-impaired shoppers, and to all shoppers during periods of increased ambient noise.

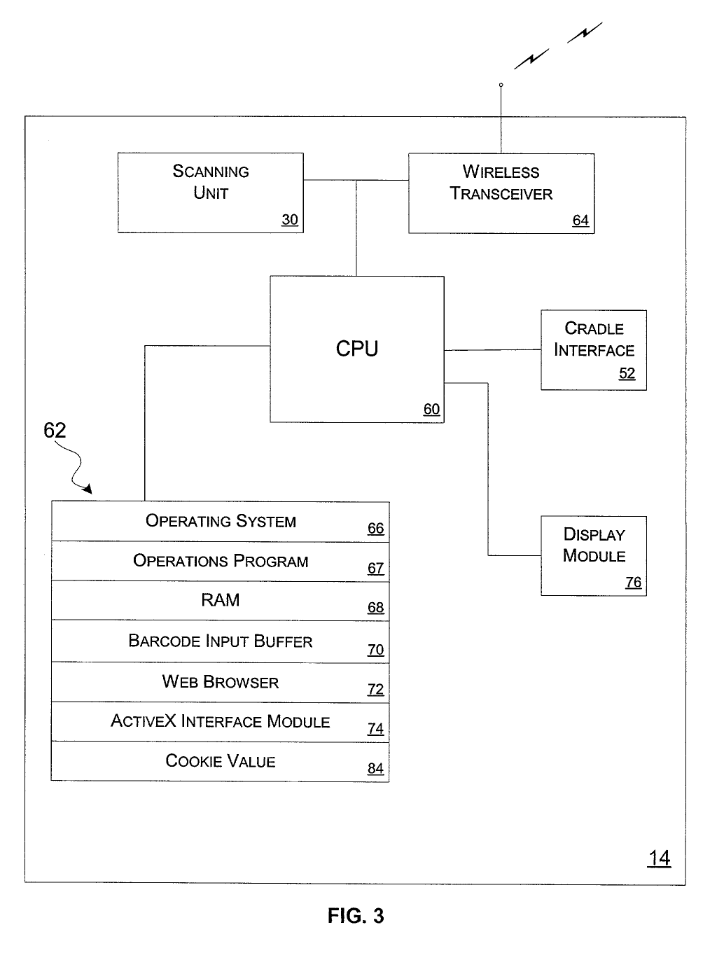

As noted above, the DSA 14 includes a scanning unit 30 capable of scanning encoded product identification information associated with products of interest. In an exemplary embodiment the scanning unit 30 will be designed to scan one and two dimensional bar code labels such as, for example, Uniform Product Code (“UPC”) labels. The scanning unit 30 initiates scanning of such encoded product identification label within its line of sight upon selection of the Scan key 45. In the preferred embodiment, scanning unit 30 is a laser scanning bar code reader containing a light source and an optical system. The optical system is operative to scan the light produced by the light source, to direct it to the bar code label of interest, and to direct the reflected light to a transducer. The reflected light is converted by the transducer into electrical signals with a suitable evaluating circuit and stored within a barcode input buffer 70 (FIG. 3). In alternate embodiments, the scanning unit 30 of the DSA 14 may be configured to obtain product identification information from products of interest using other techniques. For example, in one such alternate embodiment the products displayed in retail establishment 12 would each be tagged with a unique radio frequency (“RF”) emitting tag, which would be “read” by the scanning unit 30. Moreover, in yet other embodiments the product identification information associated with a product of interest may be manually entered into DSA 14 via touch display screen 28, thereby obviating the need for scanning unit 30.

FIG. 3 provides a block diagrammatic representation of an exemplary internal architecture of a DSA 14. As shown, each DSA 14 preferably includes a central processing unit (“CPU”) 60, a memory subsystem 62, and a wireless transceiver 64. The memory subsystem 62 holds a copy of the operating system 66 and operations program 67 for the DSA 14. In an exemplary embodiment, the operating system 66 comprises the Microsoft Windows CE operating system, although any appropriate operating system and permitting code reading could be used. Among other things, operations program 67 contains instructions that (when executed on CPU 60) control (i) connection of DSA 14 to an access point 20 of LAN 24 via wireless transceiver 64, and (ii) the sending and receiving of data to and from such access point 20. Also included within the memory subsystem 62 are working random access memory (“RAM 68”), barcode input buffer 70, a web browser 72 (e.g., Microsoft Pocket Internet Explorer) disposed to execute on the CPU 60, and an ActiveX interface module 74. In addition, the DSA 14 contains an interactive display module 76 incorporating touch display screen 28. Each of the DSAs 14 need not have this configuration, and this configuration is intended to be merely illustrative.

In operation, the web browser 72 communicates with the central host facility 16 through a wireless communication channel formed between wireless transceiver 64 and an access point 20. In an exemplary embodiment the wireless transceiver 64 and the access point 20 communicate in accordance with the Bluetooth™ (“BT”) protocol, which is a computing and telecommunications industry specification for connectivity that is both wireless and automatic. The BT protocol is described in The Specification of the Bluetooth System, Version 1.1, Feb. 22, 2001, which is incorporated herein by reference. However, it will be readily appreciated that other medium to short distance data communication schemes may also be suitably employed. In the exemplary embodiment the wireless transceiver 64 may be realized using low-cost BT microchip transceiver operative at a frequency of 2.45 GHz. The BT protocol contemplates that each participating device is assigned a unique 48-bit device address from the Institute of Electrical and Electronics Engineers 802 standard. During operation, BT devices may exchange data at a rate of up to approximately 1 megabit per second using current generation technology.

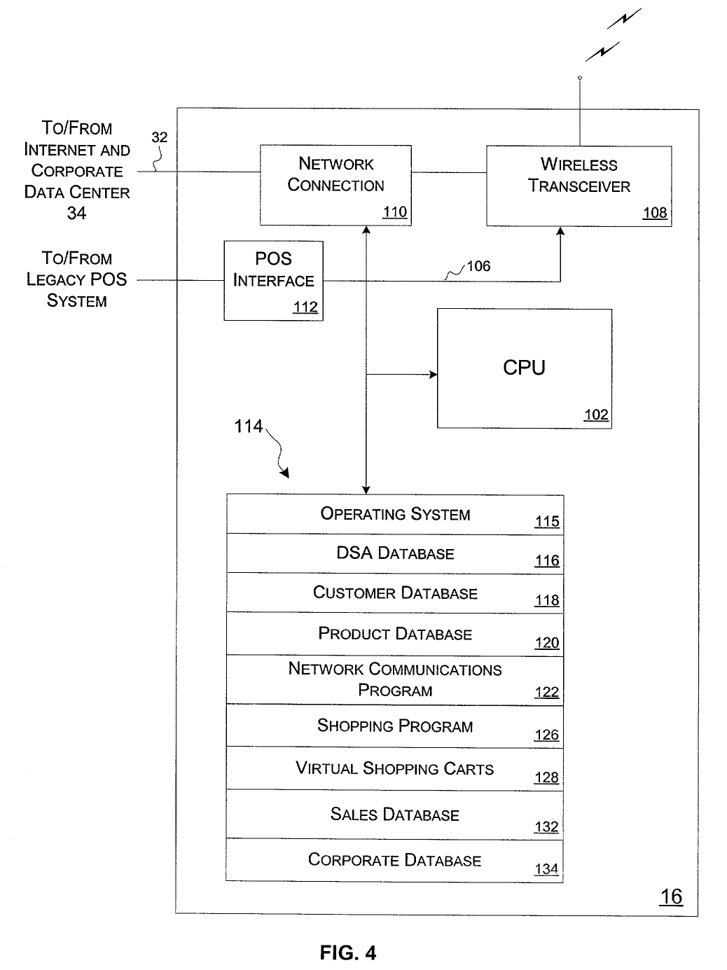

Referring again to FIG. 3, the memory subsystem 62 of each DSA 14 further stores persistent client-side state information 84, informally referred to as a “cookie”, set by the central host facility 16 upon deployment of the system 10. In accordance with one exemplary embodiment of the invention, the central host facility 14 maintains a DSA database 116 (FIG. 4) in which a terminal identification number associated with each DSA 14 is stored as a function of the value of the cookie set by the central host facility within such DSA 14. As the customer associated with a DSA 14 proceeds through the retail establishment 12 and uses its web browser 72 to make product selections and request product information in the manner described below, the central host facility 16 stores such product selections in the customer's virtual shopping cart and optionally in other associated behavioral files. During the customer's shopping session, the value of the cookie 84 within the DSA 14 transmitting such product selections and requests is made known to or requested by the central host facility 16 in connection with each such transmission. In the exemplary embodiment a customer is assigned a DSA 14 having a known terminal identification number and value of cookie 84 upon entering the retail establishment 12, and the central host facility 16 stores the product selections and requests made by a given customer on the basis of the cookie value accompanying each such selection or request. As is discussed below, during a self-checkout process the terminal identification number of the DSA 14 assigned to a customer is read and used as an index into the above-described database table to retrieve the cookie value of such DSA. Using this cookie value, the central host facility then retrieves the contents of the virtual shopping cart associated with such customer in order to facilitate the self-checkout process.

Turning to FIG. 4, the central host facility 16 functions as a local server to the DSAs 14, and includes a collection of standard server computer components necessary to effect this functionality. In particular, the central host facility 16 includes a central processing unit (CPU) 102 connected via bus 106 to wireless transceiver 108, standard external network connection 110, and memory 114 (primary and/or secondary). The central host facility 16 also may include a standard POS interface 112 (e.g., a CORBA or JCA interface) to the legacy point of sale (“POS”) system of the retail establishment 12. In the exemplary embodiment, the central host facility 16 performs the bulk of the computation and memory storage effected within the retail establishment 12, thereby reducing the computational, memory and power requirements of the DSA.

Memory 114 is sufficiently large to hold the necessary programming and data structures. As is described below, memory 114 contains operating system 115, DSA database 116, customer database 118 and product database 120. Memory 114 also contains a network communications program 122 and a shopping program 126 which each provide instructions for execution on CPU 102. The instructions provided by network communications program 122 facilitate connection of central host facility 16 to LAN 24 and to the Internet. Shopping program 126 provides instructions that, in response to product selections from a given DSA 14, add selected products to the virtual shopping cart 128 associated with the DSA 14 in memory 114. In response to requests for information concerning selected products from the DSAs 14, the shopping program 126 causes the specified information to be retrieved from product database 120. Similarly, the shopping program 126 directs the retrieval of product comparison information and the like from the CDC 34 via the Internet in response to other informational requests from the DSAs 14. In the embodiment of FIG. 1, the standard external network connection 110 provides a TCP/IP network connection to the Internet and the CDC 34 via conventional high-speed access lines (not shown). Memory 114 further includes a sales database 132 for recording sales transactions effected using the DSAs 14, and a corporate database 134 for storing various comparative product information furnished from time to time by the CDC 34.

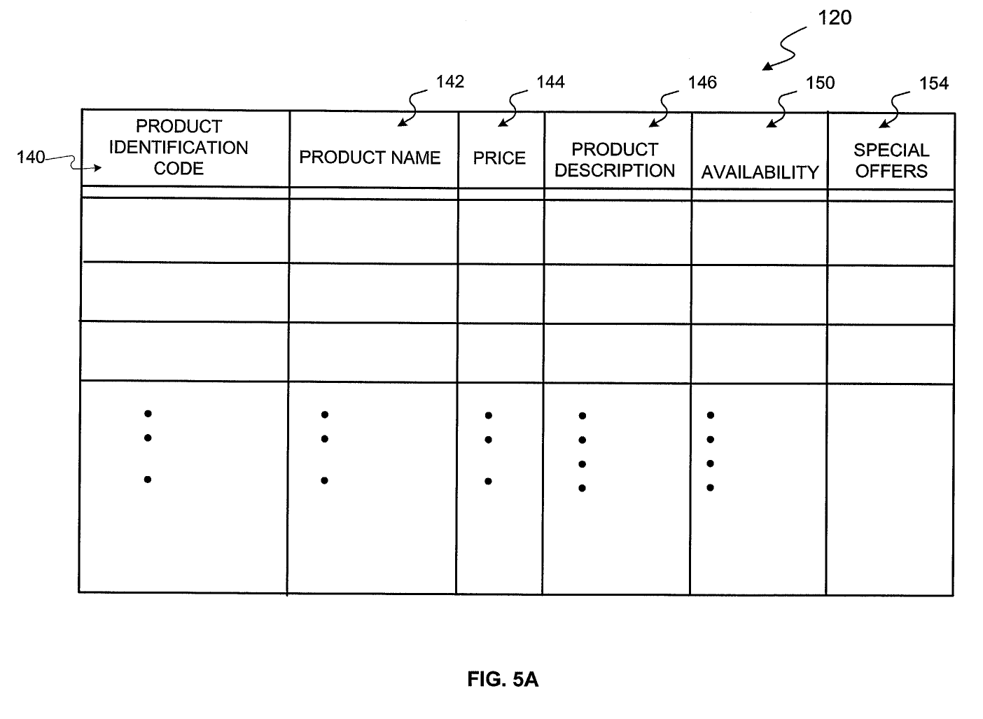

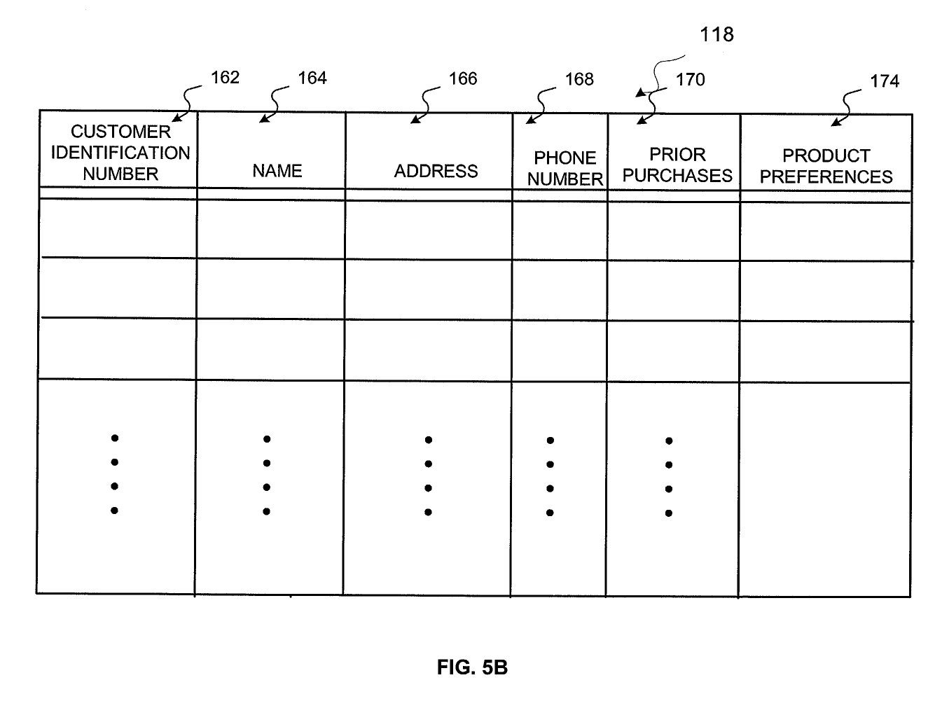

FIG. 5A illustratively represents an exemplary data structure corresponding to product database 120. In operation, product database 120 is queried upon receipt of an informational request from a DSA 14, which is typically generated following scanning an item of interest and acquisition of the item's product identification information using scanning unit 30. Product database 120 is indexed on the basis of product identification code 140, and preferably contains information such as product name 142, price 144, product description 146, availability 150 and associated special offers 154 (e.g., promotions, rebates, and tie-ins). In the exemplary embodiment the information within product database 120 may be updated using either information supplied by the CDC 34 or information entered locally at the retail establishment 12.

FIG. 5B shows an exemplary data structure corresponding to a customer database 118. As shown, customer database 118 is organized on the basis of customer identification number 162, and contains information concerning customers such as name 164, address 166, phone number 168, prior purchases 170. In addition, product preference information 174 may be derived from prior purchases 170 and stated or otherwise observed preference information.

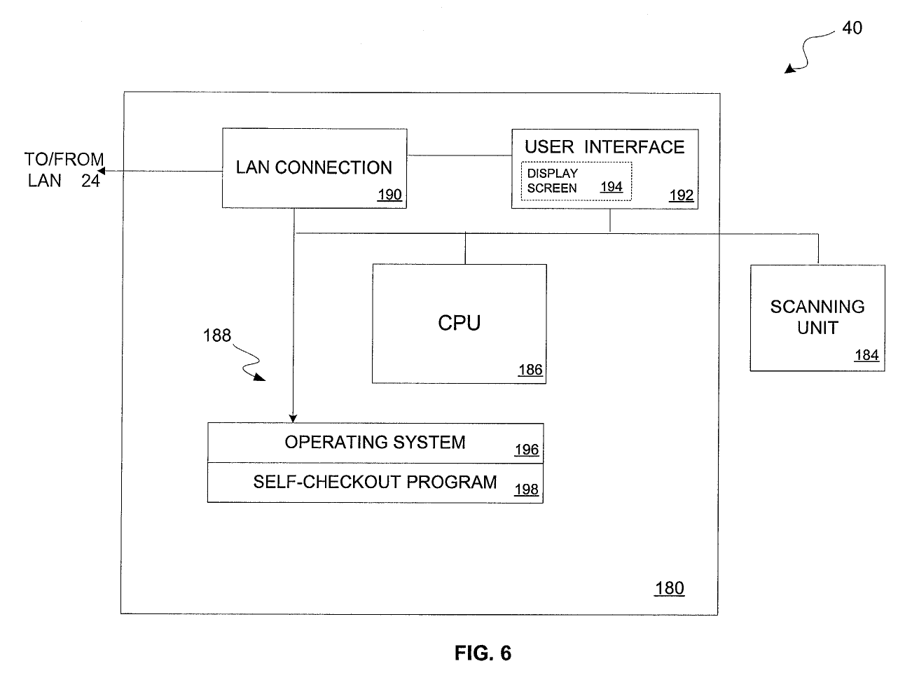

FIG. 6 provides a block diagram of an exemplary self-checkout station 40 including a self-checkout terminal 180 and attached scanning unit 184. In the embodiment of FIG. 6, the self-checkout terminal 180 is realized using standard personal computer components configured as described below and the scanning unit 184 comprises a conventional bar code scanner available from, for example, Symbol Technologies. As shown, the self-checkout terminal 180 includes a central processing unit (“CPU”) 186, a memory subsystem 188, standard LAN connection 190, and user interface subsystem 192 including a touch sensitive display screen 194. The memory subsystem 188 holds a copy of the operating system 196 and a self-checkout program 198 for the self-checkout station 40. As is described further below, self-checkout program 198 contains instructions that, when executed on CPU 186, effect the (1) acquisition of terminal identification information from a customer's DSA 14 via scanning unit 184, (2) forwarding of such terminal identification information to central host facility 16, (3) receipt from central host facility 16 of the contents of the virtual shopping cart 128 associated with the scanned terminal identification information, and (4) optional provision of such retrieved shopping cart contents to a conventional point of sale system.

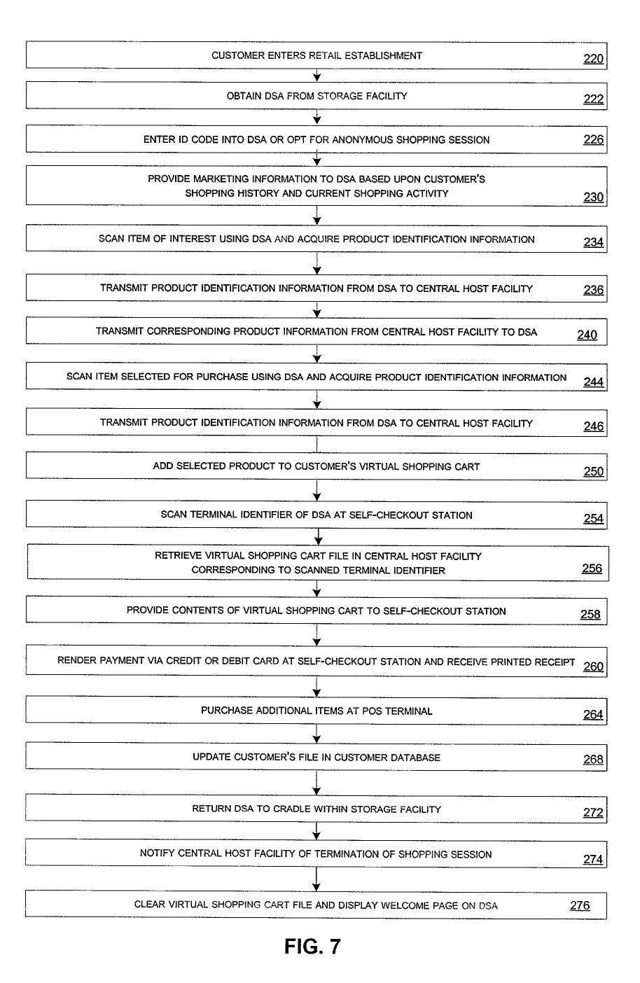

FIG. 7 is a flowchart providing a general overview of exemplary operation of the portable terminal system 10. In a step 220, a customer enters the retail establishment 12. Upon entry, the customer is provided with or retrieves a DSA 14 from one of a plurality of slots within a storage rack 22 (step 222). If the customer has been assigned a unique customer ID code (described below), then when prompted by the operations program 67 the customer may enter this code or instead opt for an anonymous shopping session (step 226). If the customer enters such an ID code, the interactive touch display screen 28 displays a welcome message tailored to the customer's preferences. In addition, the marketing information provided to the customer via the DSA 14 will be selected as described below based upon preferences of the customer discerned from both the current and previous shopping sessions (step 230).

While shopping within the retail establishment 12, the customer may encounter items of interest and desire to obtain additional information. In step 234, the customer uses the DSA 14 to scan such an item and thereby acquire the item's product identification information. The identification information is then transmitted by the wireless transceiver 64 of DSA 14 to central host facility 16 via an access point 20 of LAN 24 (step 236). In response, the shopping program 126 uses the received product identification information as a key into product database 20 and retrieves relevant product information. The shopping program 126 may also retrieve information within product database 120 corresponding to products similar to the product identified by the product identification information. All such product information is then transmitted to the requesting DSA via an access point 20 of LAN 24 and displayed by web browser 72 on touch display screen 28 (step 240).

Upon deciding to purchase an item, the customer similarly scans the item using the DSA 14 (step 244). The acquired product identification information is then similarly transmitted by the DSA 14 to central host facility 16 (step 246). Upon receipt of this product identification information at the central host facility 16, in step 250 the shopping program 126 adds the identified product to the appropriate virtual shopping cart 128 (i.e., to the virtual shopping cart identified by the cookie value associated with the web browser 72 of the transmitting DSA 14).

At the conclusion of the customer's shopping session within the retail establishment 12, the customer proceeds to a self-checkout station 40 and selects a “self-checkout” option presented by the display screen 194 of the self-checkout terminal 180 of the station 40. The customer is then prompted via the display screen 194 to use the scanning unit 184 of station 40 to read the terminal identifier affixed to the customer's DSA 14 (step 254). This terminal identifier is provided to the shopping program 126 within central host facility 16, which retrieves the cookie value corresponding to the web browser 72 of the customer's DSA 14 from DSA database 116. This enables identification of the file corresponding to the customer's virtual shopping cart 128, which as described above is stored as a function of this retrieved cookie value (step 256). In step 258, the contents of the customer's virtual shopping cart associated with this cookie value are provided to the requesting self-checkout station 40 and listed on its screen 194. The customer is then prompted via screen 194 for purchasing approval, and is given the option of rendering payment at the self-checkout station 40 or at a POS terminal 39 within the POS system 38. In the former case, the customer swipes a credit or debit card through a card reader 202 of the self-checkout station 40 and receives a printed receipt (step 260). If the customer elects to pay for all or part of the selected items at a POS terminal 39, the customer would present any printed receipt obtained from the station 40 at the POS terminal 39. Any items desired to be purchased by the customer which are not listed on the receipt could then be paid for at a POS terminal 39 using conventional means (step 264).

In an alternate embodiment the customer could proceed directly to a POS terminal 39 upon concluding shopping, at which point the customer's DSA 14 would be scanned as described above and the contents of the associated virtual shopping cart 128 would be downloaded directly to the POS terminal 39 and paid for using conventional means. In any event, a record of the purchases actually made by the customer either via the self-checkout station 40 and/or the POS terminal 39 are provided to the central host facility 16 and used by the shopping program 126 to update the customer's file maintained within customer database 118 (step 268).

Subsequent to rendering payment for purchased items at one or both of a self-checkout station 40 and a POS terminal 39, the customer returns the assigned DSA 14 to a cradle within storage rack 22 (step 272). As is described in further detail below, a cradle interface 52 (FIG. 2) of the DSA 14 detects this placement within storage rack 22, which results in termination of the customer shopping session. In particular, the DSA 14 transmits a message to the central host facility 16 via an access point 20 notifying it of termination of the customer's shopping session (step 274). In response, the shopping program 126 clears the applicable virtual shopping cart 128 and forwards a “welcome” page of the retail establishment 12 for display by the DSA 14 (step 276). In the event the customer abandons a shopping session prior to purchasing products, steps 274 and 276 would nonetheless be performed upon return of the DSA 14 to the storage rack 22.

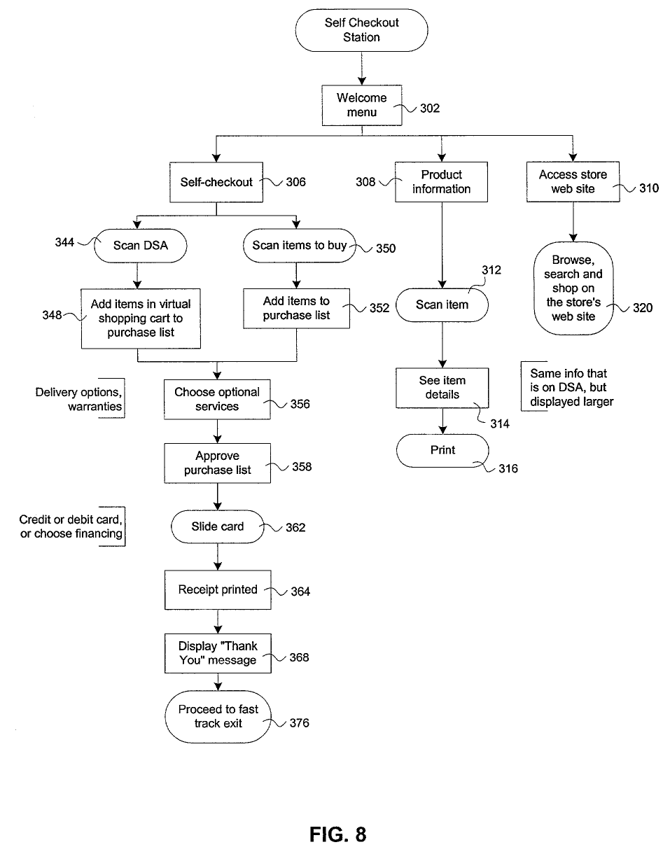

FIG. 8 is a flowchart providing a more detailed representation of an exemplary self-checkout process occurring at a self-checkout station 40. When not being utilized by a customer, the touch display screen 194 of the self-checkout terminal 180 at each self-checkout station 40 displays a welcome menu presenting a variety of options (step 302). In the exemplary embodiment these options include self-checkout 306, product information 308 and a link to the main web page 310 for the retail establishment 12 or a related entity. Upon selecting the product information option 308 presented by the interactive touch display screen 194, the customer is prompted via display screen 194 to use the scanning unit 184 of station 40 to read the product identification code affixed to the item of interest (step 312). Information concerning the scanned item of interest is then retrieved from product database 120 within the central host facility 16 and presented to the customer via display screen 194 (step 314) and optionally printed (step 316). Upon selecting the link 310, the customer is connected to the web site for the retail establishment 12 or related corporate entity and may then interact with such site in a conventional manner (step 320).

As was generally described above with reference to FIG. 7, upon selecting the self-checkout option 306 presented by the touch display screen 194, the customer is prompted via screen 194 to use the scanning unit 184 of station 40 to read the terminal identifier affixed to the customer's DSA 14 (step 344 of FIG. 8). As was also mentioned above, this permits the contents of the customer's virtual shopping cart to be provided to the requesting self-checkout station 40 and listed on the customer's purchase list displayed on screen 194 (step 348). To the extent the customer desires to purchase additional items not previously scanned via the customer's DSA 14 and recorded in the customer's virtual shopping cart, the customer may utilize the scanning unit 184 of the self-checkout station 40 to acquire the product identification codes of any such additional items (step 350). These additional items are then added to the customer's purchase list displayed upon screen 194 (step 352).

As indicated by FIG. 8, in step 356 the customer is prompted to select any of various optional services (e.g., delivery, warranty) desired to be applicable to the items identified in the completed purchase list. Upon approving the completed purchase list and optional services (step 358), the customer slides a credit or debit card through card reader 202 (step 362) in connection with rendering payment for the items identified in the purchase list. Alternatively, the customer may select from among other financing options presented via display screen 194. In step 364, a receipt is printed at the self-checkout station 40 or at a POS terminal 39 as described above. Once the receipt is printed, a “thank you” message is displayed by screen 194 (step 368) and the customer may proceed to exit the retail establishment 12 through a dedicated lane (step 376). If the customer has not previously purchased items from retail establishment 12, the receipt printed for customer (step 364) will preferably include a unique ID assigned to the customer. During the customer's next visit to the retail establishment 12 and as was described above with reference to FIG. 7, the customer may opt to shop anonymously or to enter this unique customer ID into the DSA 14 assigned to the customer at that time. Upon completion of the customer's interaction with the self-checkout station 40, a list of the items actually purchased by the customer is (unless the customer has opted for an anonymous shopping session) transmitted to the central host facility 16 and stored within the file in customer database 118 associated with the customer.

As was mentioned above, upon exiting the retail establishment 12 (step 376), the customer will return the DSA 14 assigned to customer to a cradle or the like within storage rack 22 for recharging. This placement within storage rack 22 is detected by the cradle interface 52 of the DSA 14, which provides a detection signal to the ActiveX interface module 74. In response, the ActiveX interface module 74 assembles an HTTP POST message for transmission to the central host facility 16. This message notifies the central host facility 16 of the termination of the customer's shopping session, and specifies a main HTML frame provided by the web browser 72 of the DSA 14 as the HTTP response target. In response, the shopping program 126 within the central host facility 16 clears the associated virtual shopping cart 128, and responds to the HTTP POST with the “welcome page” of the retail establishment 12 at the specified main HTML frame. This process ensures that the web browser 72 of the returned DSA 14 will display such “welcome page” to a new customer subsequently assigned to the DSA 14, and the associated virtual shopping cart 128 will be empty upon initiation of a new shopping session.

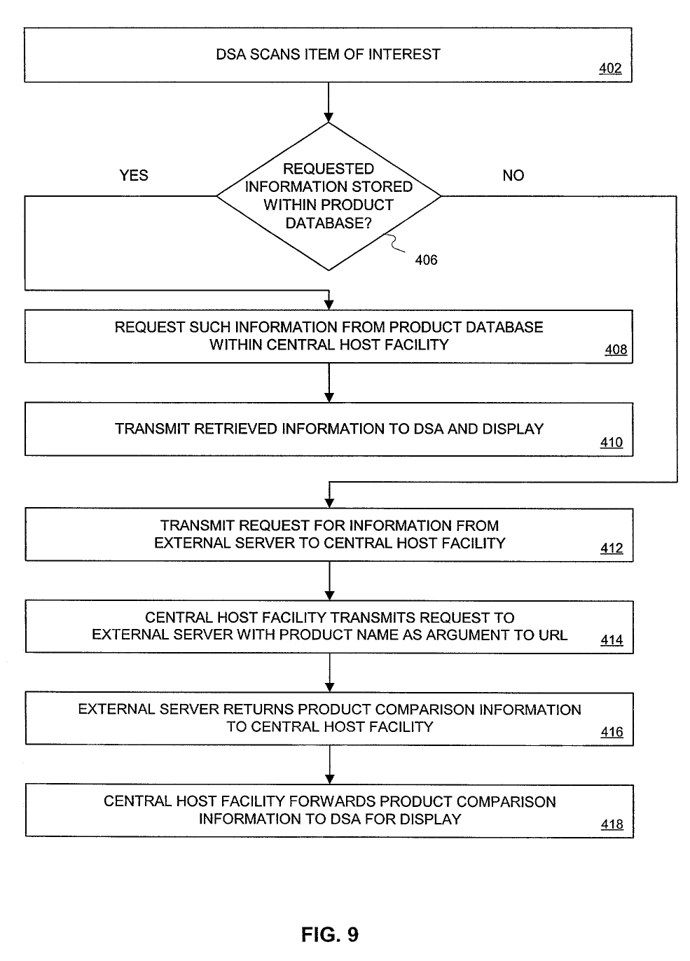

FIG. 9 is a flowchart providing a more detailed representation of one manner in which the system 10 may provide relevant product information to customers within retail establishment 12. In step 402, the customer instructs DSA 14 to scan the product identification code affixed to an item of interest. In the exemplary embodiment the customer provides this instruction by depressing scan key 45, although the instruction could also be provided through other conventional techniques (e.g., by choosing an option on a menu generated by web browser 72 and displayed by interactive touch screen 28). In response to the instruction, operations program 67 causes scanning unit 30 to scan the item of interest and store the scanned code within input buffer 70. The operations program 67 may then prompt the customer via interactive display 28 as to the type of information that is desired to be obtained (step 406). For example, if the customer requests information of a type stored within product database 120, then operations program 67 issues a request for such information from the central host facility 16 using the scanned code as an index into product database 120 (step 408). The central host facility 16 then provides this information to the interactive touch display screen 28 (step 410) for display to the customer. This information may include, for example, price, product description, links or references to compatible products, and product availability information. The content of the information provided to the customer during the preceding operation may also be influenced by the nature of the product selections currently maintained with the customer's virtual shopping cart 128, as well as by the selections made by the customer during prior shopping sessions (to the extent the customer has elected to be identified by the customer ID assigned during an initial one of such prior sessions).

If, on the other hand, the customer requests product comparison or the like, then the operations program 67 causes a request for such information to be transmitted to the central host facility 16 along with the scanned code (step 412). Within the central host facility 16, shopping program 126 may retrieve the retrieve the requested comparative information from within corporate database 134. In other embodiments the shopping program 126 may instead retrieve a corresponding URL from corporate database 134 and a product name or the like from within product database 120. The central host facility 16 may then transmit a request for information to the external server 36 corresponding to the retrieved URL, with the retrieved product name serving as an argument to the URL (step 414). In yet another embodiment, the central host facility could issue an XML-based request to the CDC 34, which would then transmit a similar request to the external server 36 or retrieve the requested information from a previously aggregated product information database 622. In the case where the request is issued to an external server 36 by either the central host facility 16 or CDC 34, the external server 36 provides the requested comparative information to the requesting entity for forwarding to the applicable DSA 14. As an example, if the retrieved URL identifies a web site hosted by the external server 36 that is devoted to providing product comparison information, then the site would provide comparative information on products related to the retrieved product name (i.e., the argument to the retrieved URL) to the central host facility 16 or CDC 34. Upon receipt at the DSA 14 of such comparative information from the central host facility 16, the operations program 67 causes the comparative information to be displayed by the web browser 72 via interactive touch display screen 28 (step 418).

In order to facilitate the concurrent display of multiple types of information via the interactive touch display screen 28, the ActiveX interface module 74 may be disposed within memory subsystem 62 of the DSA 14. In general, the interface module 74 monitors the activity of at least two of the elements of the DSA 14 responsive to the external environment, i.e., the scanning unit 30 and the cradle interface 52. One exemplary function of the ActiveX interface module 74 is to ensure that the customer is provided some indication of the activity of the scanning module, irrespective of the nature of any other information being provided to the customer via web browser 72. For example, it may be desired that the customer be informed that the scanning unit 30 is actively scanning a product or item of interest even while the customer is viewing other information via web browser 72. This ActiveX interface module 74 effects this functionality by managing a process thread operative to detect read operations of the scanning unit 30. Upon detecting such a read operation, the ActiveX interface module 74 assembles an HTTP POST request for transmission to the central host facility 16. This request passes the product identification code acquired by the scanning unit 30 and identifies a main HTML frame provided by the web browser 72 of the DSA 14 as the HTTP response target. The central host facility responds by retrieving product information from product database 120 as described above with reference to FIG. 9, and returning the retrieved product information to the specified target HTML frame. The retrieved product information may be formatted as static content, or instead may comprise dynamic streaming media. In addition, the web browser 72 may generate additional display windows in order to present related promotional opportunities.

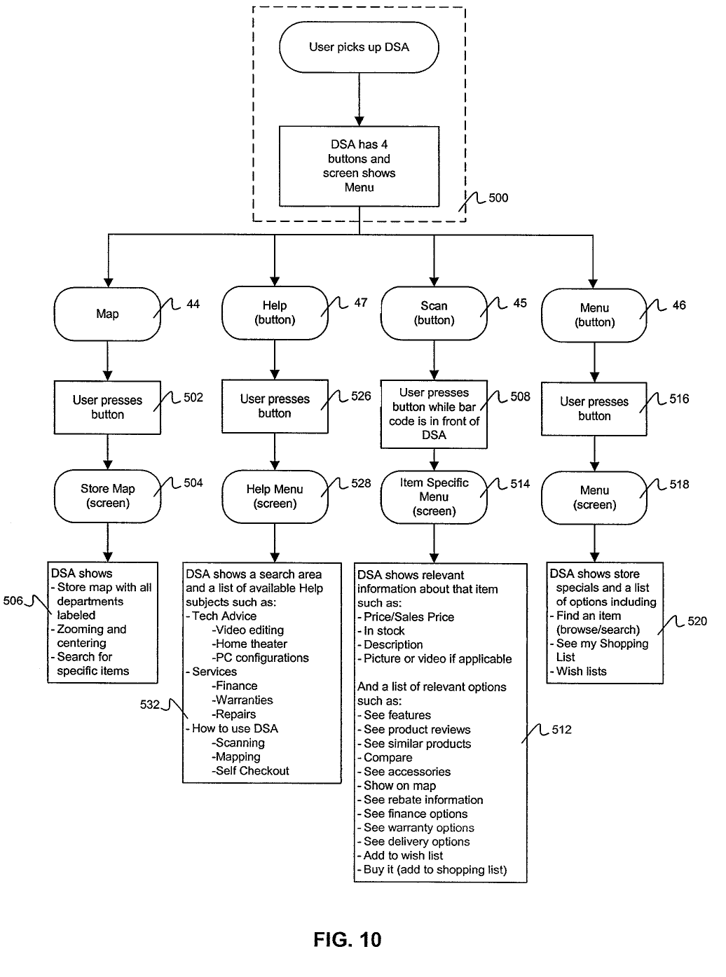

FIG. 10 is a flowchart depicting the processing associated with the dedicated keys of the DSA 14. As mentioned above, a customer may select from among the Map key 44, the Scan key 45, the Menu key 46 and the Help key 47 upon being assigned a DSA 14 (step 500). Upon selecting the Map key (step 502), a map of the retail establishment 12 is presented on the display screen 28 (step 504). In an exemplary embodiment each store department within the establishment 12 is labeled, and the display 28 may be adjusted to focus upon particular areas (step 506). When the Scan key 45 is selected with an item of interest proximate scanning unit 30 (step 508), the web browser 72 (via display 28) presents information specific to the item and a list of menu options which may be selected in order to obtain additional information (step 510). An exemplary list (512) of such item-specific information and menu options is depicted in FIG. 10.

As is shown by FIG. 10, selection of the Menu key 46 (step 516) causes web browser 72 to display a “main menu” page comprised of various menu options (step 518). In an exemplary embodiment the main menu page includes a list of promotions or “specials” currently available within the retail establishment 12, a browse/search option, a shopping list option, and a “wish list” option (step 520). Selection of the browse/search option prompts the user to enter a search term identifying a product of interest. In turn, the DSA 14 queries the product database 120 and displays any available returned information via display 28.

Upon selection of the Help key (step 526), a list of available help topics is presented via display 28 (step 528). In particular, this list may include a search field and a specific list of topics (e.g., “Tech Advice”, “Services”, “How to use DSA”) for which additional information is available (step 532). In the exemplary embodiment selection of any of these topics, or entry of a term within the search field, causes the DSA 14 to query the memory 114 of central host facility 16. In response, the host facility 16 returns the requested information to the DSA 14 for presentation via display 28. Alternatively, certain of the information relating to the displayed list of help topics (step 532) may be stored within memory 62 of the DSA 14.

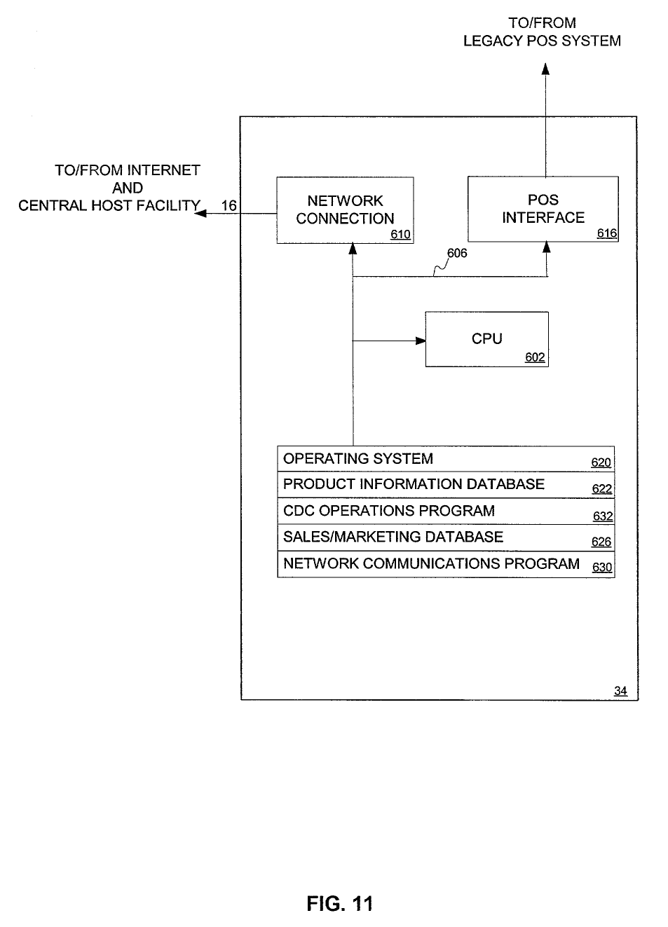

Turning now to FIG. 11, the CDC 34 serves marketing, sales and other product-related information to the central host facilities of one or more related retail facilities (e.g., central host facility 16 of retail establishment 12), and includes a collection of standard server computer components necessary to effect this functionality. In particular, the central CDC 34 includes a central processing unit (CPU) 602 connected via bus 606 to standard external network connection 610, and memory 614 (primary and/or secondary). The CDC 34 also may include a standard POS interface 616 to the legacy point of sale (“POS”) system of the retail establishment 12.

Memory 614 contains operating system 620, a product information database 622 and a sales/marketing database. Memory 114 also contains a network communications program 630 and a CDC operations program 632 which each provide instructions for execution on CPU 602. The instructions provided by network communications program 630 facilitate connection of the CDC 34 to the Internet and to central host facility 16.

During operation of the system 10, the CDC operations program 632 compiles the information within the product information database 622 by procuring product-related information from the web sites of associated vendors hosted by external servers 36. Additional such information may also of course be manually entered into the product information database 622. In one exemplary embodiment, the CDC operations program 632 replicates the information stored in the product information database 622 within the product database 120 of the central host facility 16. To the extent the central host facility 16 requests product-related information from the CDC 34 not contained within the host facility's product database 120, the CDC operations program 632 causes the specified information to be retrieved from product information database 622 or the applicable external server 36 and forwarded to the host facility 16. The CDC operations program 632 also records, within sales/marketing database 626, the product sales and customer preference information originally stored within the databases of the central host facility 16 (e.g., customer database 118 and sales database 132) and those of other retail establishments.

The CDC operations program 632 is also disposed to utilize information within the sales/marketing database 626 in implementing marketing and sales strategies and initiatives developed for the retail establishment 12 and other retail facilities. In accordance with one aspect of the invention, this enables marketing and sales initiatives to be personalized based upon customer preferences and purchasing trends. For example, products related to those items selected or investigated by a customer during a given shopping session can be recommended to the customer at the conclusion of the current shopping session (prior to checkout). Similar recommendations of product models of higher quality or price can also be made during the same shopping session on the basis of items selected earlier. This capability to offer customers “cross-sell” and “up-sell” opportunities during the same shopping session is not known to be offered by prior systems, which typically do not contemplate updating of customer preferences until after checkout has occurred. Moreover, different marketing and sales campaigns defined for retail establishments within different regions may be developed at, and deployed from, the single location of the CDC 34.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

What is claimed is:

1. A portable shopping system comprising:
a plurality of portable terminals, each having a scanning unit for acquiring product identification information associated with selected products;
a wireless communication network for communicating said product identification information provided by said plurality of portable terminals; and
a central host facility in communication with an access point for receiving said product identification information from said wireless communication network, said central host facility including
a central database including a plurality of personal shopping files respectively associated with said plurality of portable terminals, and
a central controller operative to update ones of said personal shopping files upon receipt of portions of said product identification information provided by associated ones of said portable terminals.

2. The portable shopping system of claim 1 wherein a first of said portable terminals includes a memory for storing persistent state information associated with a first terminal identifier corresponding to said first of said portable terminals.

3. The portable shopping system of claim 2 wherein said first of said portable terminals is marked with said first terminal identifier, said central host facility including a reader device for reading said first terminal identifier when said first of said portable terminals is positioned proximate said reader device.

4. The portable shopping system of claim 3 wherein said central database includes a table associating at least said first terminal identifier with said persistent state information, said central controller retrieving a first of said personal shopping files associated with said persistent state information in response to said reading of said first terminal identifier.

5. The portable shopping system of claim 1 wherein said central controller operates to create a request for product data based at least in part upon a first portion of said product identification information corresponding to a first of said selected products, wherein said request identifies a first server connected to said central host facility via an external network.

6. The portable shopping system of claim 5 wherein said first portion of said product identification information is provided by one of said plurality of portable terminals and wherein said first server provides said product data to said central controller in response to said request, said central controller causing said product data to be transmitted by said access point over said wireless communication network to said one of said plurality of portable terminals.

7. A system for self-checkout by a customer comprising:
a central host facility including a central database in which is maintained a personal shopping file associated with said customer;
a portable terminal having a scanning unit for acquiring product identification information from items selected by said customer;
a wireless communication network for enabling communication between said central host facility and said portable terminal, said portable unit transmitting said product identification information to said central host facility via said wireless communication network wherein a list of said items is stored within said personal shopping file in response to receipt at said central host facility of said product identification information;
at least one self-checkout unit in communication with said central host facility for processing a self-checkout transaction involving said at items, said self-checkout transaction including downloading said list of items from said personal shopping file in response to presentment of said portable terminal at said self-checkout unit.

8. The system of claim 7 wherein said central database maintains a plurality of additional personal shopping files associated with a corresponding plurality of additional customers, said plurality of additional shopping files storing a plurality of additional lists of items respectively selected by said plurality of additional customers using an associated plurality of additional portable terminals wherein each of said additional portable terminals includes a scanning unit for reading encoded product identification labels correlated with said items.

9. The system of claim 7 wherein said portable terminal is marked with a terminal identifier and includes permanent state information, said central database storing an association between said permanent state information and said terminal identifier.

10. The system of claim 9 wherein said permanent state information is transmitted by said portable terminal to said central host facility via said wireless communication network and is used to identify said personal shopping file.

11. The system of claim 10 wherein said terminal identifier is transmitted by said self-checkout unit to said central host facility during said self-checkout transaction, said personal shopping file being accessed upon receipt at said central host facility by using said association between said terminal identifier and said permanent state information.

12. In a self-checkout system in which at least one customer utilizes a portable terminal having an integrated scanning unit, a method for providing product marketing information to said customer, said method comprising:
storing a customer data file associated with said customer at a central host facility, said customer data file being identified by a customer identification number and including customer preference information created on the basis of shopping activity of said customer during one or more prior shopping sessions;
entering said customer identification number into said portable terminal during a current shopping session;
transmitting said customer identification number to said central host facility via a wireless communication network;
acquiring product identification information associated with a product using said integrated scanning unit and transmitting said product identification information to said central host facility; and
transmitting, from said central facility, said product marketing information to said portable terminal via said wireless communication network wherein said product marketing information is selected based upon said customer data file and said product identification information.

13. The method of claim 12 further including displaying, at said portable terminal, said product marketing information wherein said product marketing information includes at least one link to a data file associated with said product.

14. The method of claim 13 further including selecting said link via a display of said portable unit and transmitting a request for information within said data file to said central host facility via said wireless communication network.

15. The method of claim 12 further including displaying, at said portable terminal, said product marketing information wherein said product marketing information includes at least one prompt message for the purchase of a non-selected product.

16. A portable sales assistant terminal, comprising:
a processor;
a memory coupled to said processor;
a scanning unit coupled to said processor for scanning products of interest and for providing associated product identification information to said processor;
a wireless transceiver circuit coupled to said processor for transmitting said product identification information via a wireless communication channel and receiving corresponding product information; and
a display/user input device for displaying said product information through a browser executed by said processor, said memory storing persistent browser state information externally associated with said shopping terminal.

17. The portable sales assistant terminal of claim 16 wherein said shopping terminal is marked with terminal identification information externally associated with said persistent browser state information.

18. The portable sales assistant terminal of claim 16 wherein said browser is operative to display at least one page of graphical data via said display/user input device, wherein said at least one page of graphical data includes at least one link to a data file associated with a selected item identified by certain of said product identification information.

19. The portable sales assistant terminal of claim 18 wherein selection of said link via said display/user input device causes said wireless transceiver circuit to transmit a request for information within said data file over said wireless communication channel.

20. The portable sales assistant terminal of claim 16 wherein said persistent browser state information corresponds to a permanent cookie associated with said browser, and wherein said terminal identifier is marked upon an external surface of said shopping terminal.

21. The portable sales assistant terminal of claim 18 wherein said processor executes display processing software the data processing software that generates said link by performing the following tasks:
(i) transmitting said certain of said product identification information to a central host facility over said wireless communication channel using the wireless transceiver;
(ii) receiving said page of graphical data including said link over said wireless communication channel; and
(iii) displaying said page of graphical data on said display/user input device.
